(19) United States
(12) Patent Application Publication
(10) Pub. No.: US 2014/0203645 A1
(43) Pub. Date: Jul. 24, 2014

(54) CONVERTER ASSEMBLY

(71) Applicant: SIEMENS AKTIENGESELLSCHAFT, MUENCHEN (DE)

(72) Inventors: Holger Leu, Uttenreuth (DE); Andreja Rasic, Erlangen (DE)

(73) Assignee: SIEMENS AKTIENGESELLSCHAFT, MUENCHEN (DE)

(21) Appl. No.: 14/117,879

(22) PCT Filed: May 2, 2012
(86) PCT No.: PCT/EP2012/057998

§ 371 Date: Feb. 4, 2014

(30) Foreign Application Priority Data
May 10, 2011 (DE) 102011075576.4

(51) Int. Cl. H02J 4/00

(52) U.S. Cl. CPC H02J 4/00
USPC 307/52

(57) ABSTRACT

A converter assembly has at least one a.c. voltage terminal at which an alternating current can be fed in or tapped and at least one d.c. voltage terminal at which a direct current can be fed in or tapped. The converter assembly includes at least two series connections, which are connected in parallel and the external terminals of which form d.c. voltage terminals of the converter assembly. Each of the series connections that are connected in parallel includes at least two sub-modules that are connected in series, each formed with at least two switches and a capacitor. At least one of the sub-modules has a terminal at which electrical energy can be drawn from the sub-module or electrical energy can be fed into the sub-module.

The invention relates to a converter assembly having at least one a.c. voltage terminal at which an alternating current can be fed or drawn and at least one d.c. voltage terminal at which a direct current can be fed or drawn.

A converter assembly of this kind is known from the publication “An Innovative Modular Multilevel Converter Topology Suitable for Wide Power Range” (A. Lesnicar and R. Marquardt, 2003 IEEE Bologna Power Tech Conference, 23-26 Jun. 2003, Bologna, Italy). This known converter assembly is a so-called Marquardt-converter assembly comprising at least two series connections connected in parallel, the external terminals of which form d.c. voltage terminals of the converter assembly.

Each of the series connections connected in parallel comprises at least two sub-modules connected in series each comprising at least two switches and a capacitor. A suitable control of the switches enables the voltage level at the d.c. voltage terminals to be set.

The invention is based on the object of disclosing a converter assembly which is in particular universally applicable.

This object is achieved according to the invention by a converter assembly with the features as claimed in claim 1. Advantageous embodiments of the converter assembly according to the invention are disclosed in subclaims.

It is provided according to the invention that at least one of the sub-modules comprises a terminal at which electrical energy can be drawn from the sub-module or electrical energy can be fed into the sub-module.

A substantial advantage of the converter assembly according to the invention consists in the fact that—unlike known converter assemblies—this assembly comprises additional terminals at which energy can be drawn or energy can be fed. This enables the converter assembly to be used in a particularly versatile fashion in technical systems. For example, the converter assembly according to the invention can be used to distribute electrical energy, i.e. as a type of energy distribution system or as a component of a complex energy distribution system. The sub-modules of the converter assembly according to the invention can be spatially distributed, for example over an entire urban area and form local withdrawal and/or in-feed points of the energy distribution system for withdrawing and/or feeding in electrical energy.

With respect to the a.c. voltage terminals of the converter assembly, it is considered to be advantageous for each of the series connections connected in parallel to comprise an intermediary terminal lying between two sub-modules of the respective series connection in terms of potential and for each intermediary terminal to form one of the a.c. voltage terminals. For the conversion of d.c. voltage into a.c. voltage and vice versa, the at least one sub-module is preferably equipped with a sub-module-individual converter connected by its d.c. voltage terminal to the capacitor of the sub-module.

In order to enable a further voltage conversion during the withdrawal and/or the feeding-in of electrical energy in the sub-module, it is considered to be advantageous for said sub-module to comprise a sub-module-individual transformer connected to the a.c. voltage side of the sub-module-individual converter of the sub-module.

According to a first preferred embodiment of the converter assembly, it is provided that a terminal of the sub-module-individual transformer forms the terminal or one of the terminals of the sub-module at which electrical energy, and namely in the form of alternating current, can be drawn from the sub-module or fed into the sub-module.

According to a second preferred embodiment of the converter assembly, it is provided that an a.c. voltage terminal of the sub-module-individual converter forms the terminal or one of the terminals of the sub-module, at which electrical energy, and namely in the form of alternating current, can be drawn from the sub-module or fed into the sub-module.

According to a third preferred embodiment of the converter assembly, it is provided that a terminal of the sub-module-individual capacitor form the terminal or one of the terminals of the sub-module, at which electrical energy, and namely in the form of direct current, can be drawn from the sub-module or fed into the sub-module.

Preferably, the converter assembly works in a multi-phase mode, for example a three-phase mode and comprises for each phase at least one series connection each with at least two sub-modules connected in series.

The invention also relates to an energy distribution system for supplying a supply area with electrical energy, wherein the energy distribution system comprises at least one terminal for feeding electrical energy and a plurality of terminals for withdrawing the fed-in electrical energy.

It is considered to be advantageous with respect to an energy distribution system of this kind for the energy distribution system to comprise a converter assembly as claimed in any one of the preceding claims, wherein the at least one terminal of the energy distribution system for feeding the electrical energy is formed by a terminal of the converter assembly and at least one subset of the terminals of the energy distribution system for withdrawing the fed-in electrical energy to be formed by terminals of the sub-modules of the converter assembly.

With respect to the advantages of the energy distribution system according to the invention, reference is made to the above-explained advantages of the converter assembly according to the invention since the advantages of the converter assembly according to the invention substantially correspond to those of the energy distribution system according to the invention.

It is considered to be advantageous for the sub-modules to be locally distributed over the supply area to be supplied with electrical energy by the energy distribution system. This enables relatively large supply areas, for example entire urban areas, to be supplied with electrical energy by means of the sub-modules.

The invention is also considered to be a wind farm with a plurality of wind generators and a converter assembly—as described above. The wind generators are preferably each connected to a sub-module of the converter assembly.

The invention is also considered to be a method for operating a converter assembly as described above. According to the invention, electrical energy is drawn from the sub-module or electrical energy is fed into the sub-module at one terminal of at least one of the sub-modules.

The invention is described below in more detail with reference to exemplary embodiments; wherein by way of example:

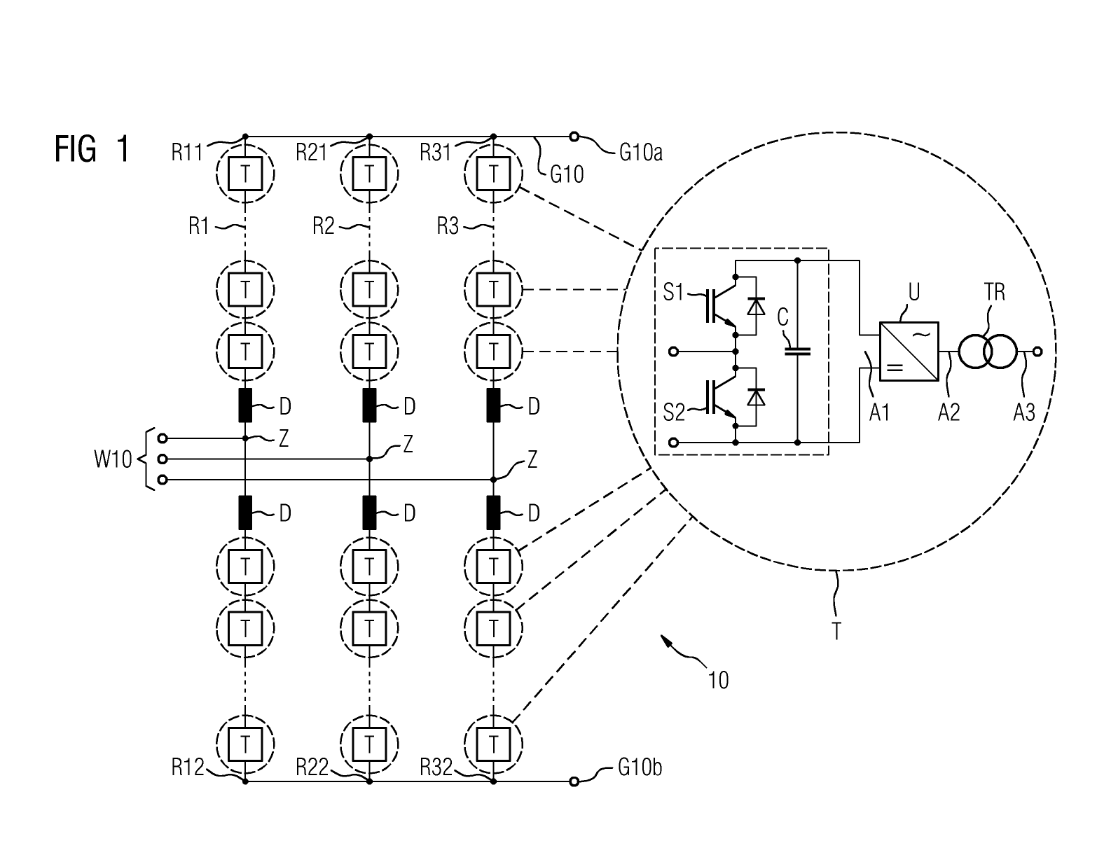

FIG. 1 shows an exemplary embodiment for a converter assembly according to the invention and

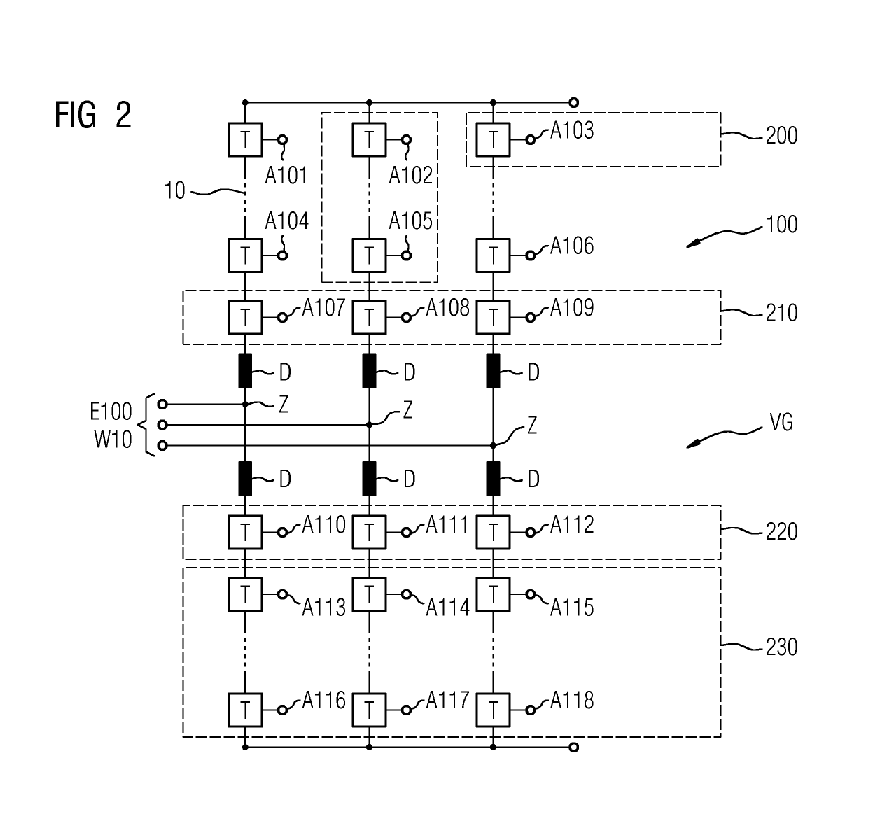

FIG. 2 shows an exemplary embodiment of an energy distribution system according to the invention, which is equipped with a converter assembly according to the invention.

In the Figures, for the sake of clarity, the same reference numbers are always used for identical or comparable components.

FIG. 1 shows an exemplary embodiment of a three-phase converter assembly 10. This comprises a.c. voltage terminals W10 for feeding alternating current. It is also equipped with a d.c. voltage side G10 comprising two d.c. voltage terminals G10a and G10b.

The converter assembly 10 comprises three series connections R1, R2 and R3 connected in parallel, the external terminals of which R11, R21 and R31 are connected to the d.c. voltage terminal G10a. The external terminals R12, R22 and R32 are connected to the d.c. voltage terminal G10b of the d.c. voltage side G10. In other words, therefore, the external terminals of the three series connections R1, R2 and R3 form the d.c. voltage side G10 of the converter assembly 10.

Each of the three series connections R1, R2 and R3 is equipped with six sub-modules T connected in series and two inductances D. Between each two inductances D there is an intermediary terminal Z, which lies between the upper three sub-modules in FIG. 1 and the lower three sub-modules in FIG. 1 in terms of potential and forms one of the three a.c. voltage terminals W10 of the converter assembly 10.

In FIG. 1, it is also possible to identify the structure of the sub-modules T by way of example. In the case of the exemplary embodiment according to FIG. 1, each of the sub-modules T comprises two switches S1 and S2, a capacitor C, a converter U and a transformer TR. The high-voltage side of the transformer TR is connected to the a.c. voltage side of the converter U.

The terminal contacts of the capacitor C of the sub-module T form a first terminal A1 of the sub-module at which electrical energy can be drawn from the sub-module T or fed into the sub-module T. Direct current can be fed or drawn at the first terminal A1.

The a.c. voltage terminals or the a.c. voltage side of the converter U form a second terminal A2 at which electrical energy can be drawn from the sub-module T or fed into the sub-module T. Alternating current can be fed or drawn at the second terminal A2.

A third terminal A3 for feeding and/or for withdrawing electrical energy is formed by the transformer terminal on the low-voltage side of the transformer TR. Alternating current can be fed or drawn at the third terminal A3.

To summarize, due to the embodiment of the sub-modules T, the converter assembly 10 enables electrical energy to be withdrawn or electrical energy to be fed in at each of the terminals A1, A2 and/or A3 of each sub-module T. Hence, the converter assembly 10 can be used as an energy distribution system.

FIG. 2 shows by way of example an exemplary embodiment for an energy distribution system 100, which is formed by a converter assembly 10 such as that explained in connection with FIG. 1.

The energy distribution system 100 comprises a terminal W10 for feeding electrical energy. In the case of the exemplary embodiment according to FIG. 2, this terminal W10 is formed by the three a.c. voltage terminals W10 of the converter assembly 10.

The energy distribution system 100 also comprises a plurality of terminals A101 to A118 which are suitable for drawing and/or for feeding electrical energy. These terminals A101 to A118 are spatially distributed over a large supply area VG, such for example an urban area. In the case of the exemplary embodiment according to FIG. 2, the terminal A101 belongs to a house 200 located in the supply area VG. The terminals A107, A108 and A109 are arranged in a small building complex 210 within the supply area VG. The terminals A110, A111 and A112 belong to a power plant 220, which supplies the local supply area VG with electrical energy. The terminals A113 to A118 are assigned to a large building complex 230, which is also located within the supply area VG.

Each of the named terminals A101 to A118 of the energy distribution system 100 is formed by one or more of the terminals A1, A2 and/or A3 of one the sub-modules T (see FIG. 1) as was explained in detail in connection with FIG. 1. In other words, it is, therefore, possible to draw electrical energy or feed electrical energy at each of the terminals A101 to A118, in that energy is drawn or fed at one or more of the terminals A1, A2 and/or A3 of each sub-module T.

The switches S1 and S2 of the sub-modules T are preferably controlled by a control center, which, for purposes of clarity, is not shown in FIGS. 1 and 2.

To summarize, the converter assembly 10 according to FIG. 1 and the energy distribution system 100 according to FIG. 2 enable the following, for example:
the connection of decentralized in-feed units and very small networks,
the formation of a powerful medium- or high-voltage coupling (d.c. voltage and a.c. voltage are possible),
a higher-ranking control that enables highly dynamic behavior of the entire system and
expanded redundancy capacities.

For example, with the converter assembly 10 according to FIG. 1 and the energy distribution system 100, it is possible to supply a plurality of decentralized small units distributed over a large area. For example, individual houses in a narrower or wider urban area can be coupled via the sub-modules to the medium- or high-voltage and supplied with low voltage.

It is also possible to interconnect a plurality of converter assemblies or a plurality of energy distribution systems. For example, it is possible for different energy distribution systems 100, such as those shown in FIG. 2, to be connected to one another via their a.c. voltage terminals W10. The advantage of this is that it does not result in a significant increase in the short-circuit capacity. Alternatively, the converter assemblies or the energy distribution systems formed therefrom can also be coupled to one another via the d.c. voltage terminals.

In the case of the interconnection of a plurality of converter assemblies or a plurality of energy distribution systems, preferably a central switching station which is capable of controlling the entire assembly is installed in the network.

The converter assembly 10 according to FIG. 1 and the energy distribution system 100 according to FIG. 2 can also be used to couple wind power turbines in wind farms to one another. For example, a wind power turbine can be connected to each sub-module of the converter assembly 10 or the energy distribution system 100 according to FIGS. 1 and 2. A terminal connection of this kind can take place via the turbine's own AC/DC-converter which is connected to the capacitor C of the respective sub-module T. Here, the amount of filtering during the feeding-in of the electrical energy generated by the wind power turbines can be kept very low so that converters with very simple topology and very simple valves (for example in the form of thyristor converters) can be used as the turbine's own AC/DC-converters. In the simplest case, it is possible, for example, to use a diode rectifier. It is also conceivable to dispense with a transformer between the turbine's own AC/DC-converter and the respective wind power generator. It is also not necessary for any fixed in feed frequency to be specified or maintained during the feeding-in into the sub-module T because each wind power turbine can be operated with its own frequency. It is also possible in a very simple way to discard individual wind power turbines in the event of an error since the sub-modules are able to work independently of the operating points of the individual generators.

Although the invention was illustrated and described in detail by the preferred exemplary embodiment, the invention is not restricted by the disclosed examples and other variations can be derived therefrom by the person skilled in the art without departing from the scope of protection of the invention.

1-12. (canceled)

13. A converter assembly, comprising:
at least one a.c. voltage terminal at which an alternating current can be fed or drawn and at least one d.c. voltage terminal at which a direct current can be fed or drawn;
at least two series connections, connected in parallel with one another and having outer terminals forming said d.c. voltage terminals of the converter assembly; and
each of said parallel-connected series connections including at least two sub-modules connected in series with one another, each of said sub-modules having at least two switches and a capacitor, and at least one of said sub-modules having a terminal for electrical energy to be drawn from said sub-module or for electrical energy to be fed into said sub-module.

14. The converter assembly according to claim 13, wherein:
each of said parallel-connected series connections comprises an intermediary terminal, connected between two said sub-modules of the respective said series connection in terms of potential; and
said intermediary terminal forms said at least one a.c. voltage terminal.

15. The converter assembly according to claim 13, wherein:
said at least one a.c. voltage terminal is one of a plurality of a.c. voltage terminals and each of said parallel-connected series connections comprises an intermediary terminal forming a respective said a.c. voltage terminal connected to lie between two said sub-modules of the respective said series connection in terms of potential.

16. The converter assembly according to claim 13, wherein at least one of said sub-modules comprises a sub-module-individual converter having a d.c. voltage side connected to said capacitor of said sub-module.

17. The converter assembly according to claim 16, wherein said at least one sub-module comprises a sub-module-individual transformer connected to said sub-module-individual converter of said sub-module.

18. The converter assembly according to claim 17, wherein a terminal of said sub-module-individual transformer forms a terminal configured to enable electrical energy in the form of alternating current to be drawn from said sub-module or fed into said sub-module.

19. The converter assembly according to claim 16, wherein a terminal of said sub-module-individual converter forms a terminal configured to enable electrical energy can be drawn from said sub-module or fed into said sub-module.

20. The converter assembly according to claim 13, wherein a terminal of said capacitor forms a terminal configured to enable electrical energy in the form of direct current to be drawn from said sub-module or fed into said sub-module.

21. The converter assembly according to claim 13, configured for a multi-phase mode of operation, and comprising, for each phase thereof, at least one series connection with at least two said sub-modules connected in series.

22. An energy distribution system for supplying a supply area with electrical energy, the system comprising:
at least one terminal for feeding in electrical energy and a plurality of terminals for withdrawing the electrical energy;
a converter assembly according to claim 13;
a terminal of said converter assembly forming said at least one terminal for feeding in the electrical energy; and
terminals of the sub-modules of said converter assembly forming at least one subset of said plurality of terminals of the energy distribution system for withdrawing the fed-in electrical energy.

23. The energy distribution system according to claim 22, wherein said sub-modules are locally distributed over the supply area to be supplied by the energy distribution system with electrical energy.

24. An electrical supply assembly, comprising:
a converter assembly according to claim 13; and
a plurality of wind generators each connected to a respective one of said sub-modules of said converter assembly.

25. A method for operating a converter assembly, the method comprising:
providing a converter assembly according to claim 13;
selectively tapping off electrical energy from one terminal of at least one of said sub-modules of said converter assembly or feeding electrical energy into said converter assembly at said one terminal.
